(19) United States
(12) Patent Application Publication
(10) Pub. No.: US 2023/0034570 A1
(43) Pub. Date: Feb. 2, 2023

(54) WATER ELECTROLYSIS SYSTEM AND CURRENT CONTROL APPARATUS

(71) Applicant: FUJITSU LIMITED, Kawasaki-shi (JP)

(72) Inventors: Yu Yonezawa, Sagamihara (JP); YOSHIYASU NAKASHIMA, Kawasaki (JP)

(73) Assignee: FUJITSU LIMITED, Kawasaki-shi (JP)

(21) Appl. No.: 17/964,078

(22) Filed: Oct. 12, 2022

Related U.S. Application Data
(63) Continuation of application No. PCT/JP2020/018857, filed on May 11, 2020.

(51) Int. Cl. C25B 9/65; H02S 40/32; C25B 9/73; C25B 15/02

(52) U.S. Cl. CPC C25B 9/65; C25B 9/73; C25B 15/02; H02S 40/32

(57) ABSTRACT

A water electrolysis system includes a plurality of conversion circuits configured to convert a first power generated by a solar power generation apparatus into a plurality of second powers, respectively, a control circuit configured to control at least a number of driven conversion circuits among the plurality of conversion circuits, and a plurality of water electrolysis cells configured to receive the plurality of second powers from the plurality of conversion circuits, respectively, wherein the control circuit includes a detector configured to detect an occurrence of a change in the first power, the change exceeding a predetermined amount per predetermined time, and the control circuit increases the number of driven conversion circuits in response to the detector detecting the occurrence of the change.

### CROSS-REFERENCE TO RELATED APPLICATIONS

This application is a continuation application of International Application PCT/JP2020/018857 filed on 2020/5/11 and designated the U.S., the entire contents of which are incorporated herein by reference.

### FIELD

The present disclosures relate to water electrolysis systems and current control apparatuses.

### BACKGROUND

Use of a water electrolysis system enables electric power obtained by solar power generation to be supplied to a water electrolysis cell, thereby decomposing water through electrolysis to generate hydrogen. Accumulating hydrogen generated from solar energy in such a manner for utilization as fuel enables the reduction of carbon dioxide emission in various fields.

In a water electrolysis system known in the art, electric power from sunlight is supplied to water electrolysis cells via respective DC/DC converters to drive the water electrolysis cells in parallel. In such a water electrolysis system, the efficiency of conversion from power to hydrogen in the entire system can be improved by changing the number of water electrolysis cells to be driven in accordance with the amount of incoming sunlight (for example, Patent Document 1).

Consideration needs to be given to the problem of deterioration of water electrolysis cells, which is caused by a sudden change in the amount of current flowing through the water electrolysis cells due to a rapid change in the generated power when the amount of incoming sunlight changes.

### Prior Art Document

### Patent Literature

[Patent Document 1] Japanese Laid-Open Patent Publication No. 2019-85602 [Patent Document 2] Japanese Laid-Open Patent Publication No. 2019-99905

### SUMMARY

According to an aspect of the embodiment, a water electrolysis system includes a plurality of conversion circuits configured to convert a first power generated by a solar power generation apparatus into a plurality of second powers, respectively, a control circuit configured to control at least a number of driven conversion circuits among the plurality of conversion circuits, and a plurality of water electrolysis cells configured to receive the plurality of second powers from the plurality of conversion circuits, respectively, wherein the control circuit includes a detector configured to detect an occurrence of a change in the first power, the change exceeding a predetermined amount per predetermined time, and the control circuit increases the number of driven conversion circuits in response to the detector detecting the occurrence of the change.

The object and advantages of the embodiment will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a drawing illustrating an example of the configuration of a water electrolysis cell;

FIG. 2 is a drawing illustrating an example of an equivalent circuit of the water electrolysis cell;

FIG. 3 is a drawing illustrating voltage applied to the water electrolysis cell and current flowing therethrough;

FIG. 4 is a drawing illustrating an example of the configuration of a water electrolysis system;

FIG. 5 is a drawing illustrating an example of the configuration of an MPPT controller;

FIG. 6 is a drawing schematically illustrating how the amount of current flowing through each water electrolysis cell changes in response to a rapid change in the amount of incoming sunlight;

FIG. 7 is a drawing illustrating the configuration that increases the number of DC/DC converters to be driven so as to reduce the amount of current flowing through each water electrolysis cell;

FIG. 8 is a drawing illustrating the configuration that drives only some of the DC/DC converters in response to a rapid change in the amount of incoming sunlight;

FIG. 9 is a drawing illustrating the response of a related-art system configuration to an abrupt change in the amount of incoming sunlight; and

FIG. 10 is a drawing illustrating the response of the water electrolysis system of the present disclosure to an abrupt change in the amount of incoming sunlight.

### DESCRIPTION OF EMBODIMENTS

In the following, embodiments of the present invention will be described in detail with reference to the accompanying drawings.

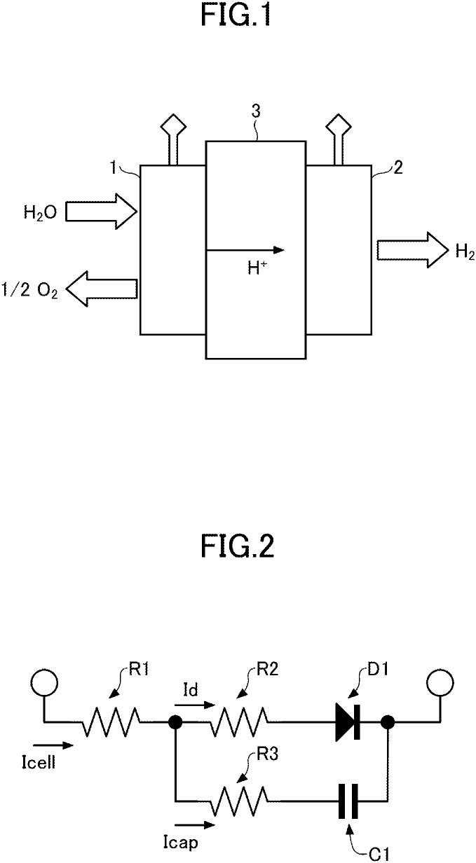

FIG. 1 is a drawing illustrating an example of the configuration of a water electrolysis cell. The water electrolysis cell includes an anode electrode 1, a cathode electrode 2, and a diaphragm 3. In the case of alkaline water electrolysis, the diaphragm 3 is provided to separate hydrogen and oxygen, and the anode electrode 1, the cathode electrode 2, and the diaphragm 3 are disposed in an electrolytic cell filled with a KOH aqueous solution of about 20% to 30%. As the diaphragm 3 in the case of alkaline water electrolysis, for example, an asbestos membrane, a porous PTFE (polytetrafluoroethylene) membrane or the like is used. In the case of solid polymer water electrolysis, the diaphragm 3 such as a perfluoroethylene sulfonic acid-based cation exchange membrane also serves as an electrolyte. A DC voltage is applied between the anode electrode 1 and the cathode electrode 2 to decompose water through electrolysis to generate hydrogen.

FIG. 2 is a drawing illustrating an example of an equivalent circuit of the water electrolysis cell. The equivalent circuit of the water electrolysis cell includes resistors R1 to R3, a diode D1, and a capacitance C1. A current Icell flowing through the water electrolysis cell is the sum of a current Id flowing through the diode D1 and a current Icap flowing through the capacitance C1. The capacitance C1 is a capacitance component existing between the anode 1 and the cathode 2, and is as large as a few farads (F). Accordingly, a change in the voltage applied between the anode 1 and the cathode 2 causes the capacitance C1 having a large capacitance value to be charged or discharged. As a result, a large amount of inrush current flows for an instant.

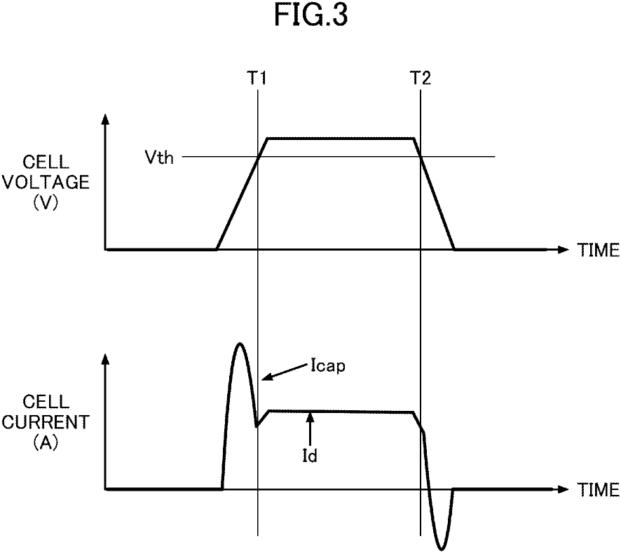

FIG. 3 is a drawing illustrating voltage applied to the water electrolysis cell and current flowing therethrough. When voltage applied to the water electrolysis cell is lower than the threshold-voltage Vth of the diode D1 in the equivalent circuit, the cell current Icell illustrated in FIG. 2 becomes equal to the current Icap flowing through the capacitance C1. That is, before time T1 and after time T2, all the current flowing through the water electrolysis cell is the current flowing through the capacitive component. Therefore, when the voltage rises, a large inrush current (charging current) flows as illustrated as a current Icap in FIG. 3. Also, when the voltage drops, a large discharge current flows for an instant in the opposite direction.

When a large current as described above flows for an instant through the water electrolysis cell, the water electrolysis cell deteriorates. The technology disclosed in the present application provides a mechanism for reducing the deterioration of water electrolysis cells in a system that drives a plurality of water electrolysis cells in parallel.

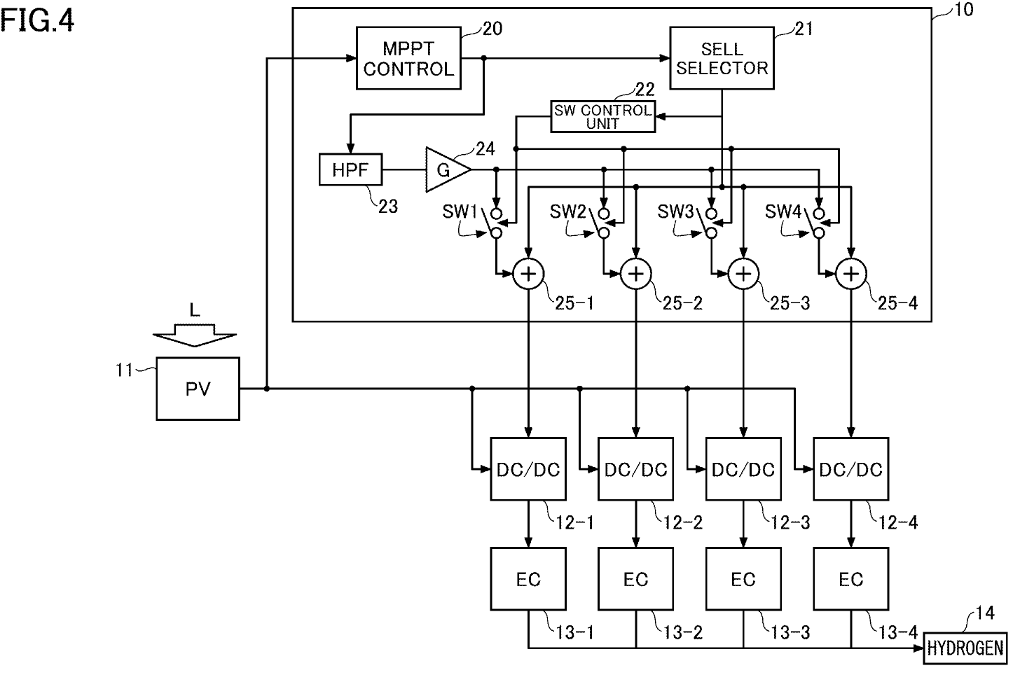

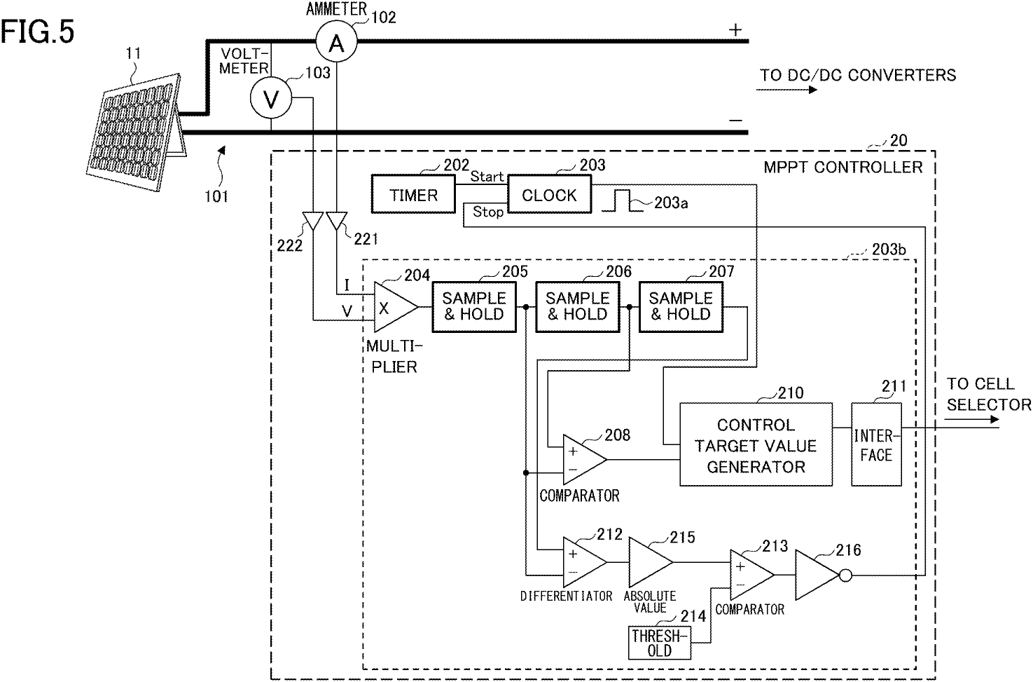

FIG. 4 is a drawing illustrating an example of the configuration of a water electrolysis system. The water electrolysis system illustrated in FIG. 4 includes a control circuit 10, a solar panel 11, DC/DC converters 12-1 to 12-4, water electrolysis cells 13-1 to 13-4, and a hydrogen storage device 14.

The solar panel 11 has a plurality of solar cells arranged on a panel surface. The solar panel 11 is a power generation device that converts the energy of sunlight into DC power by using a photovoltaic effect to output the DC power. The DC/DC converters 12-1 to 12-4 are a plurality of conversion circuits that convert a first power (direct-current power) generated by the power generation device into a plurality of respective second powers (direct-current powers). The water electrolysis cells 13-1 to 13-4 receive the plurality of second electric powers from the plurality of DC/DC converters 12-1 to 12-4, respectively. The water electrolysis cells 13-1 to 13-4 decompose water through electrolysis by the second electric powers received from the solar panel 11 to generate hydrogen. The hydrogen generated by the water electrolysis cells 13-1 to 13-4 is stored in a hydrogen storage device 14 (for example, a hydrogen tank).

The number of DC/DC converters 12-1 to 12-4 and the number of water electrolysis cells 13-1 to 13-4 illustrated in FIG. 4 are merely an example. As will be described later, the number of water electrolysis cells (= the number of DC/DC converters) may be any number that allows the inrush current to the individual water electrolysis cells to be kept below an allowable limit, and may preferably be a minimum necessary number that allows the inrush current to be kept below an allowable limit.

The control circuit 10 controls at least the number of DC/DC converters to be driven among the plurality of DC/DC converters 12-1 to 12-4. More specifically, the control circuit 10 drives one or more DC/DC converters selected from the DC/DC converters 12-1 to 12-4 at a designated duty ratio. For example, when only the two DC/DC converters 12-1 and 12-2 are driven at a duty ratio of 0.5, the control circuit 10 may supply a duty ratio of 0.5 to the DC/DC converters 12-1 and 12-2, and supply a duty ratio of 0 to the remaining DC/DC converters 12-3 and 12-4. Alternatively, the control circuit 10 may output four select signals in addition to signals indicating four duty ratios, set the select signals for the DC/DC converters 12-1 and 12-2 to be driven to 1, and set the select signals for the remaining DC/DC converters to 0.

One of the basic functions of the control circuit 10 is to draw power from the solar panel 11 at voltage and current values at which the solar panel 11 can generate maximum power. In other words, one of the basic functions of the control circuit 10 is to adjust the DC voltage value and the DC current value in the first power generated by the solar panel 11 such that the power generated by the solar panel 11 is maximized.

The characteristics of a solar cell are such that an output voltage value decreases as an output current value increases, and there is an optimum combination of an output current value and an output voltage value such that the output power obtained by the product of the output current value and the output voltage value becomes maximum. When an output current value becomes greater than the output current value of the optimum combination, an output voltage value decreases, and the output power obtained by the product of these decreases. In addition, when an output current value becomes less than the output current value of the optimum combination, an output voltage value increases, but the output power obtained by the product of these decreases. Therefore, it is necessary to control the output current value and the output voltage value of the solar cell such that the optimum combination of an output current value and an output voltage value can be maintained.

For the purpose of describing the above-noted control, a configuration in which electric power from the solar panel 11 is supplied to one water electrolysis cell is considered. In such a configuration, one DC/DC converter may be provided between the solar panel 11 and the water electrolysis cell. The DC/DC converter controls an output voltage from the converter by a PWM operation according to a duty ratio. When the duty ratio increases, the converter output voltage increases and the converter output current decreases, and when the duty ratio decreases, the converter output voltage decreases and the converter output current increases. When the DC/DC converter has ideal characteristics, the output power of the solar panel 11 (i.e., input power of the DC/DC converter) and the input power of the water electrolysis cell (i.e., output power of the DC/DC converter) are equal to each other. By adjusting the duty ratio of the DC/DC converter, the output voltage and output current of the DC/DC converter as well as the input power of the DC/DC converter can be adjusted, so that the output power of the solar cell can be controlled to be maximum.

MPPT (Maximum Power Point Tracking) control is generally performed as control for maximizing the output power of a solar cell. In this MPPT control, for example, the duty ratio D1 in the initial state is increased by ΔD, and a new duty ratio D2 = D1 + ΔD is set. When the power P output from the solar panel 11 is increased by this change, that is, when P(D2) > P (D1) , the duty ratio is further increased by ΔD. Conversely, when the power output from the solar panel 11 decreases due to this change, that is, when P(D2) < P(D1), the duty ratio is conversely decreased by ΔD, and, then, is further decreased by ΔD. By performing such control, it is possible to reach a point at which the output power becomes maximum by the hill-climbing method.

The control circuit 10 is based on the above-described MPPT control. In the configuration in which the plurality of DC/DC converters 12-1 to 12-4 are controlled as illustrated in FIG. 4, the control circuit 10 may perform a control operation that drives each DC/DC converter under a high conversion efficiency condition. In this control operation, when the amount of incoming sunlight is small, hydrogen is generated by a small number of water electrolysis cells by driving a small number of DC/DC converters. When the amount of incoming sunlight is large, hydrogen is generated by a large number of water electrolysis cells by driving a large number of DC/DC converters. With this arrangement, the water electrolysis system as a whole can realize highly efficient sunlight-to-hydrogen conversion. Details of such a technology are disclosed in, for example, Patent Document 1 previously described.

In the technique disclosed in the present application, the control performed by the control circuit 10 further increases the number of DC/DC converters to be driven among the DC/DC converters 12-1 to 12-4 when the output power of the solar panel 11 rapidly changes. More specifically, the control circuit 10 includes a detector 23 that detects the occurrence of a change in the first power exceeding a predetermined amount per predetermined time. When the detector 23 detects the occurrence of such a change, the control circuit 10 increases the number of DC/DC converters to be driven among the DC/DC converters 12-1 to 12-4. As a result, since the number of water electrolysis cells to be driven among the water electrolysis cells 13-1 to 13-4 increases, the current amount of the inrush current flowing per water electrolysis cell decreases, thereby preventing the deterioration of the water electrolysis cells.

The control circuit 10 includes an MPPT controller 20, a cell selector 21, an SW control unit 22, a detector (HPF) 23, a gain adjuster 24, switch circuits SW1 to SW4, and adders 25-1 to 25-4. In FIG. 4, a boundary between each circuit or functional block indicated by each box and another circuit or functional block basically indicates a functional boundary, and does not necessarily correspond to separation of a physical position, separation of an electrical signal, separation of a control logic, or the like. Each circuit or functional block may be a single hardware module physically separated from other blocks to some extent, or may represent a single function in a hardware module physically integrated with other blocks.

The MPPT controller 20 performs the above-described MPPT control and outputs a control signal such that the output voltage of the solar panel 11 is maximized. That is, the MPPT controller 20 generates a control signal used for controlling the DC/DC converters 12-1 to 12-4 (a control signal for generating signals for controlling the DC/DC converters) so as to maximize the first power generated by the solar panel 11. This control signal may be an analog signal indicating a value in the range of 0 to 1 corresponding to a duty ratio. Alternatively, the control signal may be a digital signal including a plurality of bits indicating a value in a range from 0 to 1 corresponding to the duty ratio.

FIG. 5 is a drawing illustrating an example of the configuration of the MPPT controller 20. The MPPT controller 20 includes a timer 202, a clock generator 203, amplifiers 221 and 222, a multiplier 204, sample-and-hold circuits 205 to 207, and a comparator 208. The MPPT controller 20 further includes a control target value generator 210 (hereinafter also referred to as a “generator 210”), an interface circuit 211, a differentiator 212, an absolute value circuit 215, a comparator 213, and a stop signal generator 216.

An ammeter 102 measures an output current of the solar panel 11 (i.e., a current flowing through an output line 101), and a voltmeter 103 measures an output voltage of the solar panel 11 (i.e., a voltage applied to the output line 101). A voltage signal representing the measured voltage value V and a current signal representing the measured current value I are input into the MPPT controller 20 through the amplitude adjustment amplifiers 221 and 222. The voltage value V represents a voltage value of the DC output power of the solar panel 11. The current value I represents a current value of the DC output power of the solar panel 11.

The timer 202 is an interval timer for starting the operation of the MPPT controller 20. The timer 202 transmits a one-pulse start signal (Start) to the clock generator 203 once in a predetermined time (for example, a 10-second cycle). Upon receiving the start signal, the clock generator 203 generates and outputs a one-pulse clock 203a having a constant cycle (for example, a 100-millisecond cycle), and activates circuitry (i.e., circuitry 203b inside a thin dotted line) that operates in synchronization with the clock 203a.

When the clock 203a is supplied to the circuitry 203b, the voltage signal and the current signal are converted by the multiplier 204 into a power signal representing a power value. The power value represented by the power signal is stored in the sample-and-hold circuit 205. The sample-and-hold unit includes three stages comprised of cascade-connected sample-and-hold circuits 205 to 207. The sample-and-hold circuits 205 to 207 hold a power value Pnew corresponding to a current clock 203a, a power value Pold corresponding to an immediately preceding clock 203a, and a power value Poold corresponding to a second preceding clock 203a.

The comparator 208 compares the power value Pnew corresponding to the current clock 203a with the power value Pold corresponding to the immediately preceding clock 203a, and outputs the comparison result to the generator 210.

The result that the current power value Pnew is larger than the previous power value Pold supports the estimation that the control signal (i.e., duty ratio), which is the output of the MPPT controller 20, has changed in such a direction as to increase the output power of the solar panel 11 between the measurement of the previous power value Pold and the measurement of the current power value Pnew. Therefore, when the comparator 208 detects that the current power value Pnew is larger than the previous power value Pold, the generator 210 changes the duty ratio in the same direction as the direction in which the duty ratio was changed last time. As a result, the output power of the solar panel 11 can be further increased and brought closer to a maximum power Psolar_max.

On the other hand, the result that the current power value Pnew is smaller than the previous power value Pold supports the estimation that the control signal (i.e., duty ratio) which is the output of the MPPT controller 20 has changed in such a direction as to decrease the output power of the solar panel 11 between the measurement of the power value Pold and the measurement of the power value Pnew. Therefore, when the comparator 208 detects that the current power value Pnew is equal to or less than the previous power value Pold, the generator 210 changes the duty ratio in a direction opposite to the direction in which the duty ratio was changed last time. As a result, the output power of the solar panel 11 can be increased to approach the maximum power Psolar_max.

The interface circuit 211 may be a communication port that converts the duty ratio into a digital communication signal in the case of digital communication, and may be a digital-to-analog converter that converts the duty ratio into an analog voltage in the case of transmission using an analog voltage signal.

The differentiator 212 outputs a difference between the power value Pnew corresponding to the current clock 203a and the power value Poold (the value from the sample-and-hold circuit 207) corresponding to the second preceding clock 203a. The absolute value circuit 215 derives and outputs the absolute value of the difference. The comparator 213 causes the stop signal generator 216 to generate a clock stop signal (Stop) when the absolute value of the difference obtained by the absolute value circuit 215 becomes smaller than a predetermined threshold 214. Upon receiving the clock stop signal generated by the stop signal generator 216, the clock generator 203 stops outputting the clock 203a regardless of whether or not the start signal is received. The generator 210 may continue outputting the same duty ratio that was output immediately before the stop of the MPPT controller 20 during the period in which the MPPT control is stopped. Thus, when the output power of the solar panel 11 reaches the maximum power point, the MPPT control of the MPPT controller 20 is stopped, and the maximum output power state can be maintained. Instead of stopping the MPPT control as described above, the MPPT control may be constantly performed.

Referring back to FIG. 4, the cell selector 21 generates a plurality of duty ratios to be supplied to the DC/DC converters 12-1 to 12-4 based on the control signal (i.e., duty ratio) output from the MPPT controller 20. The cell selector 21 may include, for example, a CPU (Central Processing Unit) and a memory, and the CPU executing a control program stored in the memory may calculate a plurality of duty ratios. More specifically, the cell selector 21 may control a plurality of duty ratios based on the single duty ratio output from the MPPT controller 20 such that a power conversion operation by each of the one or more driven DC/DC converters is performed in a state of maximum efficiency.

The detector 23 may be a high-pass filter into which the control signal (i.e., duty ratio) output from the MPPT controller 20 is input. The high-pass filter may be an analog filter that receives a duty ratio that is an analog signal, or may be a digital filter that receives a duty ratio that is a digital signal. The high-pass filter may detect the occurrence of a change exceeding a predetermined amount per predetermined time in the duty ratio, thereby detecting the occurrence of a change exceeding a predetermined amount per predetermined time in the first electric power output by the solar panel 11. Use of a high-pass filter as the detector 23 in this manner allows a simple circuit configuration to detect the occurrence of a change exceeding a predetermined amount per predetermined time at an appropriate timing.

The switch circuits SW1 to SW4 are provided in one to-one correspondence with the DC/DC converters 12-1 to 12-4, and can be set to either a conductive state or a non-conductive state. Upon being placed in the conductive state, the switch circuits SW1 to SW4 supply signals responsive to the output of the detector 23 (i.e., signals obtained by adjusting the output of the detector 23 with the gain adjuster 24) to the adders 25-1 to 25-4, respectively. The adders 25-1 to 25-4 receive the signals responsive to the output of the detector 23 via the switch circuits SW1 to SW4, respectively, and add the signals to the plurality of duty ratios received from the cell selector 21.

The SW control unit 22 generates switch circuit control signals for setting the switch circuits SW1 to SW4 to a conductive state or a nonconductive state based on the plurality of duty ratios generated by the cell selector 21 (or based on the select signals for selecting DC/DC converters to be driven). Specifically, the SW control unit 22 generates the switch circuit control signals such that only the switch circuits SW1 to SW4 corresponding to the DC/DC converters that are not driven by the cell selector 21 become conductive. The value of a switch circuit control signal supplied to the switch circuit to be in the conductive state may be 1 (high), and the value of the switch circuit control signal supplied to the switch circuit to be in the nonconductive state may be 0 (low), for example.

In the manner described above, the control circuit 10 can supply a duty ratio specified by the signal responsive to the output of the high-pass filter serving as the detector 23 to a DC/DC converter that is not driven by the cell selector 21. Thus, the DC/DC converters can be driven at the duty ratio responsive to the amount of change in the first electric power. The amount of inrush current increases as the amount of change in the first electric power increases, and also increases as the speed of change in the first electric power increases. Likewise, the output of the high-pass filter serving as the detector 23 increases as the amount of change in the first power increases, and increases as the speed of change in the first power increases. Therefore, by supplying a duty ratio specified by the signal responsive to the output of the high-pass filter to a DC/DC converter, the DC/DC converter can be driven with the duty ratio whose value is responsive to the magnitude of inrush current. This enables the DC/DC converters to output currents at a conversion ratio responsive to the magnitude of inrush current, thereby properly reducing the amount of current flowing through the water electrolysis cells and reliably preventing deterioration of the water electrolysis cells.

Here, the switch circuits SW1 to SW4 and the adders 25-1 to 25-4 function as a signal supply circuit that supplies a duty ratio indicated by the signal responsive to the output of the high pass filter serving as the detector 23 to the DC/DC converters that are not driven by the cell selector 21. Use of the switch circuits and the adders in this fashion allows a simple circuit configuration to cause the DC/DC converters to output currents at a conversion ratio responsive to the magnitude of inrush current, thereby preventing deterioration of the water electrolysis cells.

As described above, the MPPT controller 20 continuously varies the control signal (i.e., duty ratio) output therefrom in order to track the maximum power point by the MPPT control. When the detector 23 detects any variation by the MPPT control in the control signal, the detector 23 ends up erroneously detecting variation unrelated to the variation in the amount of incoming sunlight. Therefore, the detector 23 is preferably configured to detect only those frequencies which are higher than a frequency f_{MPPT} attributable to the variation generated by the MPPT control. In particular, a cut-off frequency f_{c} (i.e., the frequency corresponding to the lower limit of the pass band of the high pass filter) is preferably set higher than the frequency f_{MPPT}. Setting the cut-off frequency of the high-pass filter in this manner enables the occurrence of a change exceeding a predetermined amount per predetermined time to be appropriately detected without being affected by intentional signal fluctuation for the MPPT control.

With the above-described configuration, when the detector 23 detects the occurrence of a change exceeding a predetermined amount per predetermined time in the first power output from the solar panel 11, the control circuit 10 increases the number of DC/DC converters to be driven among the DC/DC converters 12-1 to 12-4. As a result, since the number of water electrolysis cells to be driven among the water electrolysis cells 13-1 to 13-4 increases, the amount of inrush current flowing per water electrolysis cell decreases, thereby properly preventing the deterioration of the water electrolysis cells.

In the water electrolysis system illustrated in FIG. 4, the number N of DC/DC converters 12-1 to 12-4 and water electrolysis cells 13-1 to 13-4 is four. The number N of water electrolysis cells 13-1 to 13-4 is preferably set to a number at which the water electrolysis cells do not deteriorate due to an inrush current. This number can be calculated as follows.

When a conversion ratio between the input voltage Vin and the output voltage Vout of the DC/DC converters 12-1 to 12-4 is D (= Vout/Vin), the output current of the DC/DC converters 12-1 to 12-4 is ⅟D times the input current. When the maximum value of the inrush current output from the solar panel 11 is I_{sc}, the maximum value of the total amount of current output from the DC/DC converters 12-1 to 12-4 is I_{sc}/D. When the total current amount is equally divided by the N water electrolysis cells 13-1 to 13-4, the maximum value of the current flowing through each water electrolysis cell is I_{sc}/(N ·D). This current value is preferably smaller than the rated value Imax of each water electrolysis cell for the purpose of preventing the deterioration of each water electrolysis cell. Therefore, the following condition is preferably satisfied: I_{sc}/(N·D) > Imax. As a result, the number N preferably satisfies the relationship defined as: N> I_{SC}/(Imax·D).

When the detector 23 is a high-pass filter, the output value of the high-pass filter is responsive to the impedance values or the like of passive elements provided therein in the case of an analog filter, and is responsive to filter coefficient values or the like in the case of a digital filter. Therefore, the output value of the high-pass filter needs to be normalized to an appropriate value (i.e., a value in the range of 0 to 1) as the duty ratio of a DC/DC converter. When K DC/DC converters are driven, a duty ratio that is ⅟K times the duty ratio used when one DC/DC converter is driven may be supplied to each DC/DC converter. The gain adjuster 24 may appropriately perform such gain adjustment.

When the input of the high-pass filter rapidly decreases, the output value of the high-pass filter has a negative value. Even in such a case, since a large discharge current flows through the water electrolysis cell, the number of DC/DC converters and water electrolysis cells to be driven is preferably increased in the water electrolysis system disclosed in the present application. Therefore, the output value of the high-pass filter serving as the detector 23 is preferably an absolute value of the value that is obtained by performing high-pass filtering on the input. Alternatively, the negative output value of the high-pass filter may be left as it is, and the gain adjuster 24 may convert the output value of the high-pass filter into its absolute value.

When the cell selector 21 drives all the DC/DC converters 12-1 to 12-4, the SW control unit 22 may keep all the switch circuits SW1 to SW4 in a nonconductive state. That is, since all the DC/DC converters 12-1 to 12-4 are driven, the number of DC/DC converters to be driven cannot be increased any more, and the control circuit 10 may be configured to perform nothing in particular as a countermeasure against inrush current. Alternatively, the SW control unit 22 may be configured to place all the switch circuits SW1 to SW4 in a conductive state, and add the duty ratio indicated by the signal responsive to the high pass filter output to the duty ratios supplied to the DC/DC converters. In this case, a maximum value limiting function may be provided such that the maximum value of an adder output becomes 1. With such a configuration, the amount of current flowing through each water electrolysis cell can be reduced upon the occurrence of inrush current.

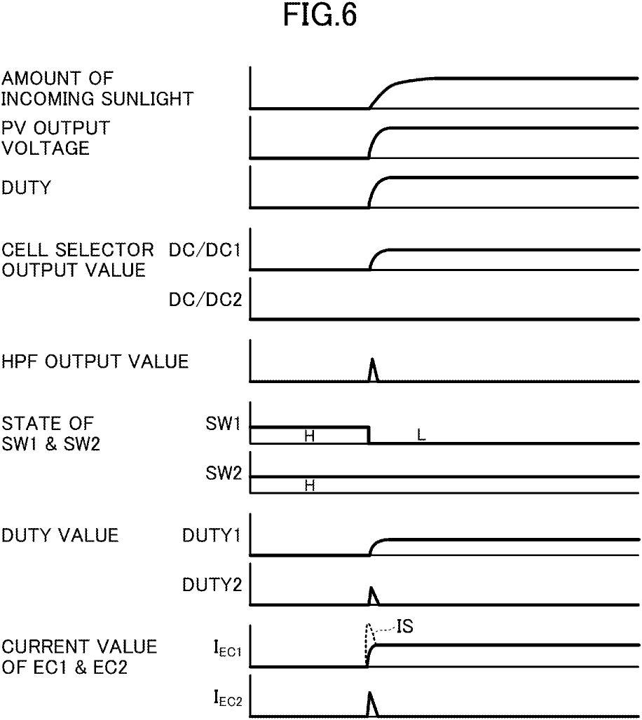

FIG. 6 is a drawing schematically illustrating how the amount of current flowing through each water electrolysis cell changes in response to a rapid change in the amount of incoming sunlight. For the sake of convenience, FIG. 6 is directed to an example in which the number of DC/DC converters and the number of water electrolysis cells are each two, and such an example is used to illustrate a response to a rapid change in the amount of incoming sunlight.

As illustrated in FIG. 6, when the amount of incoming sunlight increases, a PV output voltage output from the solar panel increases. In response to this increase in the PV output voltage, a duty ratio DUTY output from the MPPT controller also increases. In the example illustrated in FIG. 6, the optimum efficiency is obtained by driving only one of the two DC/DC converters with respect to the increased amount of incoming sunlight. Therefore, among the outputs of the cell selector, an output value DC/DC1 for the first DC/DC converter increases as illustrated, and an output value DC/DC2 for the second DC/DC converter remains to be 0.

An HPF output value output from the high-pass filter serving as a detector has a non-zero value only during a steep change of the duty ratio DUTY given as an input, and thus has a waveform whose value increases only for a moment and immediately returns to 0 as illustrated in the drawing.

The conductive and non-conductive states of the switch circuits SW1 and SW2 controlled by the output of the SW control unit are indicated by signal values SW1 and SW2 (i.e., switch circuit control signals) in FIG. 6. When this signal is in a high (H) state, the switch circuit is in a conductive state, and when this signal is in a low (L) state, the switch circuit is in a non-conductive state.

A duty ratio DUTY1 supplied to the first DC/DC converter via the adder is the same as the signal DC/DC1 in FIG. 6. A duty ratio DUTY2 supplied to the second DC/DC converter via the adder is a duty ratio corresponding to the HPF-output value supplied via the switch circuit in the conductive state. A current I_{EC1} flowing through a first water electrolysis cell EC1 is a current output from the first DC/DC converter driven according to the duty ratio DUTY1. A current I_{EC2} flowing through the second water electrolysis cell EC2 is a current output from the second DC/DC converter driven according to the duty ratio DUTY2.

In the conventional water electrolysis system, the current I_{EC2} flowing through the second water electrolysis cell EC2 is 0, and an inrush current indicated as IS is superimposed on the current I_{EC1} flowing through the first water electrolysis cell EC1. In the water electrolysis system of the present disclosure, since an amount of current corresponding to the HPF value flows through the second water electrolysis cell EC2, the amount of current I_{EC1} flowing through the first water electrolysis cell EC1 is reduced. It is thus possible to avoid deterioration of the water electrolysis cells.

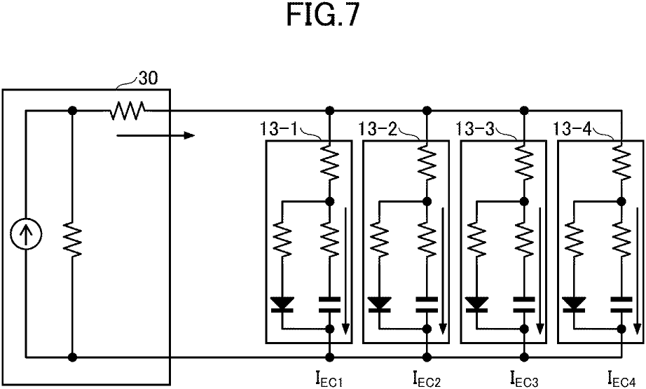

FIG. 7 is a drawing illustrating a configuration in which the amount of current flowing through each water electrolysis cell is reduced by increasing the number of DC/DC converters to be driven. In FIG. 7, a circuit 30 is an equivalent circuit of the solar panel and the DC/DC converters. The current supplied from the equivalent circuit 30 is distributed to the water electrolysis cells 13-1 to 13-4 as a current I_{EC1}, a current I_{EC2}, a current I_{EC3}, and a current I_{EC4}. This arrangement reduces the amount of current flowing through each water electrolysis cell, compared with the case in which the current is supplied to one water electrolysis cell, for example, thereby preventing deterioration of the water electrolysis cells.

In the above-described embodiment, all the installed DC/DC converters are driven by supplying the duty ratio from the detector 23 to all the DC/DC converters that are not driven by the cell selector 21. It is preferable to drive all the DC/DC converters from the viewpoint of reducing the amount of current flowing through each water electrolysis cell by distributing the inrush current to the plurality of water electrolysis cells to prevent deterioration. However, when the amount of inrush current is not so large, it is not always necessary to drive all of the installed DC/DC converters.

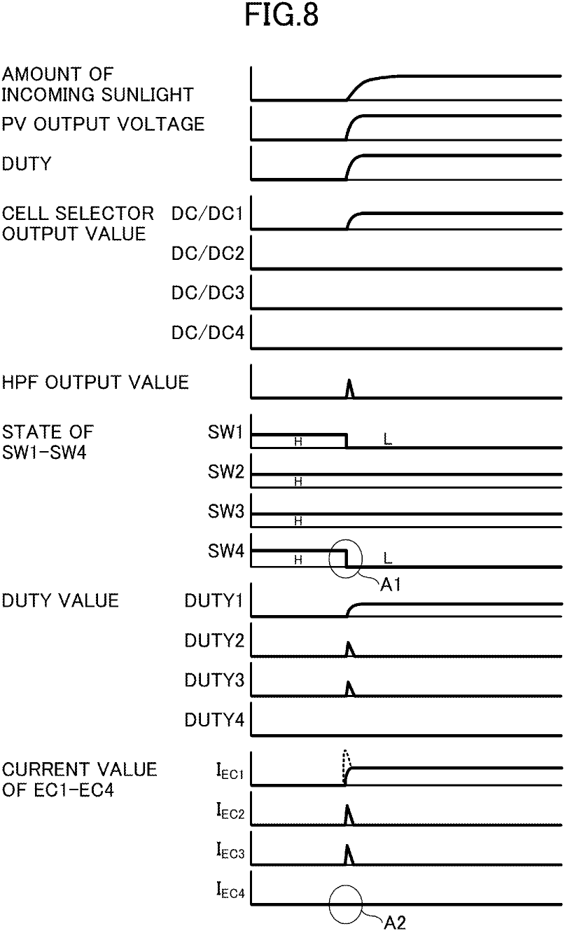

FIG. 8 is a drawing illustrating an operation in which only some of the DC/DC converters are driven in response to a rapid change in the amount of incoming sunlight. FIG. 8 is directed to an example in which the number of DC/DC converters and the number of water electrolysis cells are each four, and such an example is used to illustrate a response to a rapid change in the amount of incoming sunlight.

As illustrated in FIG. 8, when the amount of incoming sunlight increases, a PV output voltage output from the solar panel increases. In response to this increase in the PV output voltage, a duty ratio DUTY output from the MPPT controller also increases. In the example illustrated in FIG. 8, the optimum efficiency is obtained by driving only one DC/DC converter among the four DC/DC converters after the increase in the amount of incoming sunlight. Therefore, among the outputs of the cell selector, an output DC/DC1 for the first DC/DC converter is increased as illustrated, and the outputs DC/DC2 to DC/DC4 for the second to fourth DC/DC converters remains to be zero.

The HPF output value output from the high-pass filter serving as a detector has a non-zero value only during a steep change of the duty ratio DUTY given as an input, and thus has a waveform whose value increases only for a moment and immediately returns to 0 as illustrated in the drawing.

The conductive and non-conductive states of the switch circuits SW1 to SW4 controlled by the outputs of the SW control unit are indicated by signal values SW1 to SW4 (i.e., switch circuit control signals) in FIG. 8. When this signal is in a high (H) state, the switch circuit is in a conductive state, and when this signal is in a low (L) state, the switch circuit is in a non-conductive state. As indicated at A1 in FIG. 8, the SW control unit sets the switch circuit control signal SW4 to low (L) for the fourth DC/DC converter.

The duty ratio DUTY1 supplied to the first DC/DC converter via the adder is the same as the signal DC/DC1 in FIG. 8. The duty ratio DUTY2 supplied to the second DC/DC converter via the adder is a duty ratio corresponding to the HPF-output value supplied via the switch circuit in the conductive state. Similarly, the duty ratio DUTY3 supplied to the third DC/DC converter via the adder is a duty ratio corresponding to the HPF-output value supplied via the switch circuit in the conductive state. The duty ratio DUTY4 supplied to the fourth DC/DC converter is zero as illustrated in FIG. 8.

A current I_{EC1} flowing through a first water electrolysis cell EC1 is a current output from the first DC/DC converter driven according to the duty ratio DUTY1. A current I_{EC2} flowing through the second water electrolysis cell EC2 is a current output from the second DC/DC converter driven according to the duty ratio DUTY2. A current I_{EC3} flowing through the third water electrolysis cell EC3 is a current output from the third DC/DC converter driven according to the duty ratio DUTY3. A current I_{EC4} flowing through the fourth water electrolysis cell EC4 is zero as illustrated at A2 in FIG. 8, which corresponds to the fact that the duty ratio DUTY4 is zero.

As illustrated in the above-described example, the water electrolysis system disclosed in the present application is not limited to a configuration in which all the DC/DC converters are driven. As long as the amount of current flowing through each water electrolysis cell can be set to be less than or equal to the rated current, only some but not all of the installed DC/DC converters may be driven to cause current to flow through only some but not all of the installed water electrolysis cells.

As described above, in the water electrolysis system of the present disclosure, the number of DC/DC converters to be driven among the DC/DC converters 12-1 to 12-4 is increased upon detecting the occurrence of a change exceeding a predetermined amount per predetermined time in the first electric power generated by the solar panel 11. As a result, since the number of water electrolysis cells to be driven among the water electrolysis cells 13-1 to 13-4 increases, the amount of inrush current flowing per water electrolysis cell decreases, thereby preventing deterioration of the water electrolysis cells. In the following, a description will be given with respect to the results of computer simulation demonstrating that the current flowing through a water electrolysis cell is reduced by the water electrolysis system disclosed in the present application.

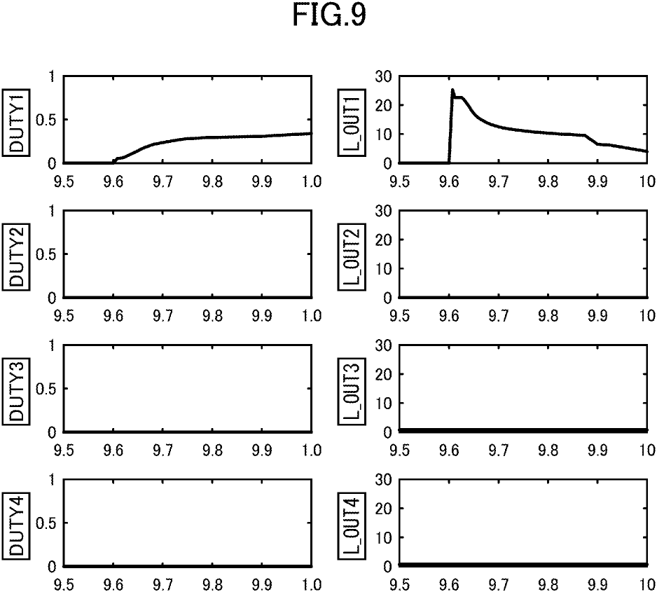

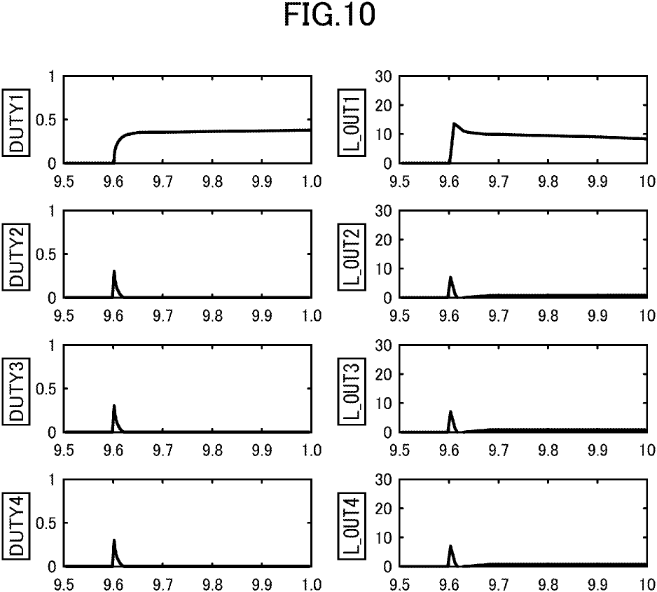

FIG. 9 illustrates the response of a related-art system configuration to an abrupt change in the amount of incoming sunlight. FIG. 10 is a drawing illustrating the response of the water electrolysis system of the present disclosure to an abrupt change in the amount of incoming sunlight. In calculating these responses, the cell threshold (i.e., the threshold of the diode D1 illustrated in FIG. 2) was 4.5 V, and the number of stacked cells is 3. The cell parasitic capacitance is 1F, and the rated current of each cell is 20A. Further, the conventional water electrolysis system is such that the SW control unit 22, the detector 23, the gain adjuster 24, the adders 25-1 to 25-4, and the switch circuits SW1 to SW4 are removed in the configuration illustrated in FIG. 4.

In the conventional water electrolysis system illustrated in FIG. 9, when the amount of incoming sunlight increases, among the plurality of duty ratios DUTY1 to DUTY4 output from the cell selector, only the duty ratio DUTY1 increases from 0. Accordingly, a current L_OUT1 flows only in the first water electrolysis cell among the four water electrolysis cells, and the current amount temporarily exceeds the rated current, i.e., 20A.

In the water electrolysis system disclosed in the present application and illustrated in FIG. 10, when the amount of incoming sunlight increases, values larger than 0 appear in all of the plurality of duty ratios DUTY1 to DUTY4 output from the cell selector 21. To be more specific, the duty ratio DUTY1 increases from 0, and the duty ratios DUTY2 to DUTY4 also temporarily increase from 0. In response to these, currents L_OUT1 to L_OUT4 flow through all the water electrolysis cells 13-1 to 13-4, and any current amount does not exceed the rated current, i.e., 20A.

According to at least one embodiment, it is possible to reduce deterioration of water electrolysis cells in a system that has a plurality of water electrolysis cells driven in parallel.

The present invention is not limited to the above-disclosed examples. For example, the current control apparatus (i.e., the control circuit 10 and the DC/DC converters 12-1 to 12-4) disclosed in the present application can be used for other power generation mechanisms (for example, wind power generation) in addition to solar power generation, and can also be used for other electrolytic cells in addition to a water electrolytic cell.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A water electrolysis system, comprising:
a plurality of conversion circuits configured to convert a first power generated by a solar power generation apparatus into a plurality of second powers, respectively;
a control circuit configured to control at least a number of driven conversion circuits among the plurality of conversion circuits; and
a plurality of water electrolysis cells configured to receive the plurality of second powers from the plurality of conversion circuits, respectively,
wherein the control circuit includes a detector configured to detect an occurrence of a change in the first power, the change exceeding a predetermined amount per predetermined time, and the control circuit increases the number of driven conversion circuits in response to the detector detecting the occurrence of the change.

2. The water electrolysis system according to claim 1, wherein the control circuit includes a maximum power point tracking control circuit configured to generate a control signal used to control operations of the plurality of conversion circuits so as to maximize the first power generated by the solar power generation apparatus, and the detector is a high-pass filter that receives the control signal as an input.

3. The water electrolysis system according to claim 2, wherein each of the plurality of conversion circuit is a DC/DC converter configured to control an output voltage and an output current by a PWM operation according to a supplied duty ratio, and
wherein the control circuit includes:
a cell selector configured to generate a plurality of duty ratios to be respectively supplied to the plurality of conversion circuits based on the control signal; and
a signal supply circuit configured to supply a duty ratio indicated by a signal responsive to an output of the high-pass filter to a conversion circuit that is not driven by the cell selector among the plurality of conversion circuits.

4. The water electrolysis system according to claim 3, wherein the signal supply circuit includes:
a plurality of switch circuits provided in a one-to-one correspondence with the plurality of conversion circuits and configured to be set to either a conductive state or a non-conductive state; and
a plurality of adders configured to receive the signal responsive to the output of the high-pass filter via the plurality of switch circuits, respectively, and add the signal to the plurality of duty ratios received from the cell selector, respectively,
wherein among the plurality of switch circuits, a switch circuit corresponding to the conversion circuit that is not driven by the cell selector is set to a conductive state.

5. The water electrolysis system according to claim 3, wherein the signal supply circuit supplies the duty ratio indicated by the signal responsive to the output of the high-pass filter to not all but only some of conversion circuits that are not driven by the cell selector among the plurality of conversion circuits.

6. The water electrolysis system according to claim 2, wherein a cutoff frequency of the high-pass filter is higher than a frequency of variation generated by maximum power point tracking control.

7. A current control apparatus comprising:
a plurality of conversion circuits configured to convert a first power generated by a power generator into a plurality of second powers, respectively, and to supply the plurality of second powers to a plurality of electrolytic cells, respectively; and
a control circuit configured to control at least a number of driven conversion circuits among the plurality of conversion circuits,
wherein the control circuit includes a detector configured to detect an occurrence of a change in the first electric power, the change exceeding a predetermined amount per predetermined time, and the control circuit controls an amount of current supplied to each of the plurality of electrolytic cells by increasing the number of driven conversion circuits in response to the detector detecting the occurrence of the change.
